(19) United States
(12) Patent Application Publication
(10) Pub. No.: US 2008/0063921 A1
(43) Pub. Date: Mar. 13, 2008

(54) PROTON CONDUCTOR FOR FUEL CELL, ELECTRODE FOR FUEL CELL INCLUDING THE SAME, AND FUEL CELL EMPLOYING THE ELECTRODE

(75) Inventors: Suk-gi HONG, Yongin-si (KR); Myung- jin Lee, Yongin-si (KR); Eun-sung Lee, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/742,822

(22) Filed: May 1, 2007

(30) Foreign Application Priority Data
Sep. 11, 2006 (KR) 2006-87448

(51) Int. Cl. H01M 8/02; H01M 4/58; H01M 8/04; H01M 4/88

(52) U.S. Cl. 429/40; 429/12; 429/218.2; 502/101

(57) ABSTRACT

A proton conductor for fuel cells including a hydrophilic block and a hydrophobic block, an electrode for fuel cells employing the same and a fuel cell employing the electrode. The proton conductor, which is phosphoric acid based mono-ester or di-ester including an amphiphilic block, is added during the preparation of catalyst layers, and thus the viscosity of the composition may decrease and the dispersion thereof can be improved. Since the proton conductor has an amphiphilic property, the distribution of phosphoric acid can be effectively controlled. Thus, efficiency of the catalyst is improved, and fuel cells having improved efficiency can be prepared by employing an electrode including the catalyst.

### CROSS-REFERENCE TO RELATED PATENT APPLICATIONS

This application claims the benefit of Korean Patent Application No. 2006-87448, filed Sep. 11, 2006, in the Korean Intellectual Property Office, the disclosure of which is incorporated herein in its entirety by reference.

### BACKGROUND OF THE INVENTION

1. Field of the Invention

Aspects of the present invention relate to a proton conductor for a fuel cell and a fuel cell employing the same, and more particularly, to a proton conductor for a fuel cell that effectively controls the distribution and movement of a liquid electrolyte in a catalyst layer and secures the diffusion path for gaseous reactants, an electrode for fuel cells employing the same, and a fuel cell employing the electrode.

2. Description of the Related Art

A high temperature solid polymer electrolyte membrane fuel cell generally uses polybenzimidazole membranes impregnated with phosphoric acid as an electrolyte in which the phosphoric acid facilitates the proton transfer therethrough. The membrane is similar to liquid electrolyte type fuel cells such as phosphoric acid fuel cells (PAFC) and molten carbonate fuel cells (MCFC) as the distribution and movement of liquid electrolyte or ions between the electrodes within the fuel cell are required to be controlled. To achieve such control, PAFCs have used polytetrafluoroethylene (PTFE) as a binder and MCFCs have regulated the size of pores in the electrodes.

However, as control has been established through use of binders and physical structures, attention has not been dedicated to the efficient use of promoters and dispersing agents to increase the efficiency of the catalysts in the fuel cell electrode. Therefore, there is a need to improve the efficiency of catalysts through use of promoters to direct ions between electrodes in the fuel cell stack.

### SUMMARY OF THE INVENTION

Aspects of the present invention provide a proton conductor for fuel cells that improves the utilization of Pt electrochemical catalysts by efficiently controlling the distribution and movement of liquid electrolytes or ions in the catalyst layer and securing the diffusion path for gaseous reactants, an electrode for fuel cells employing the same, and a fuel cell employing the electrode.

According to an aspect of the present invention, there is provided a proton conductor for fuel cells which includes a phosphoric acid or phosphate based compound including a hydrophilic block and a hydrophobic block.

According to another aspect of the present invention, there is provided an electrode for fuel cells including the proton conductor, a metal catalyst, and a binder.

According to another aspect of the present invention, there is provided a fuel cell employing the electrode.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a graph illustrating voltage versus current densities in fuel cells; and

FIG. 2 is a graph illustrating voltage versus current density at a low current region in the fuel cell.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

A proton conductor for a fuel cell according to aspects of the present invention is a phosphoric acid based mono-ester or di-ester including a hydrophilic block and a hydrophobic block; that is, the proton conductor is a mono-ester phosphate or a di-ester phosphate including at least one amphiphilic oligomer or at least one hydrophobic oligomer.

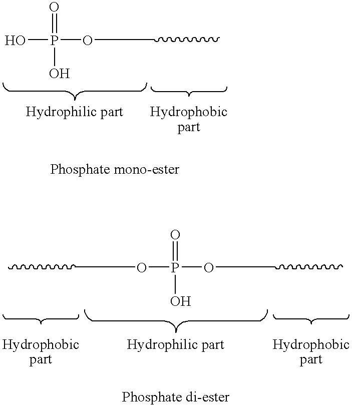

Here, in the phosphate mono-ester, a phosphate ester group, or phosphate, or ester phosphate, or phosphoric acid group, with several alkoxy groups is used as a hydrophilic portion and alkyl group having about 15 carbons is used as a hydrophobic portion. In the phosphate diester shown above, a disubstituted phosphate ester group having two chains of several alkoxy groups is used as the hydrophilic portion and an alkyl group is bound to each end of the hydrophilic portion so that there is formed a hydrophilic portion disposed between two hydrophobic portions. The extent to which the hydrophilic portion is hydrophilic can be adjusted by repeating alkoxy groups of different lengths. For example, ethoxy groups can be repeated to increase the relative hydrophilicity of the hydrophilic groups when compared to the repetition of pentoxy groups.

When the proton conductor is introduced into a catalyst layer, the hydrophilic block (hydrophilic portion) approaches a catalyst particle (e.g., Pt) and an aliphatic or aromatic group which is the hydrophobic block (hydrophobic portion) approaches a metal catalyst support (e.g., carbon); and thus, the liquid electrolyte, generally the phosphoric acid electrolyte, is distributed along the hydrophilic block around the catalyst particles. Since the proton conductor is amphiphilic, the distribution of phosphoric acid can be effectively controlled. Thus, efficiency of the catalyst is improved, and fuel cells having improved efficiency can be prepared employing an electrode including the catalyst.

Phosphoric acid, phosphoric acid group, phosphate, and phosphate ester generally refer to H₃PO₄, but may also include pyrophosphoric acid (H₂P₂O₇), tripolyphosphoric acid (H₅P₃O₁₀), or tetrapolyphosphoric acid (H₆P₄O₁₃) among others.

The proton conductor according to aspects of the present invention can be represented by Formula 1.

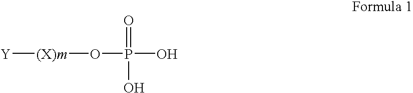

Where X is —(OCH₂CH₂)ₙ—, an ethoxy group acting as part of the hydrophilic portion,

Y is CH₃—(CH₂)ₖ-(Phenylene)_{z}- where the phenylene is a disubstituted benzene ring, and the alkyl group and phenylene act as the hydrophobic portion,

n is an integer between 1 and 10,

k is an integer between 1 and 15,

m is 0 or 1, and

z is 0 or 1.

When m is 0 and z is 1, the phenylene group is substituted for one of the protons of the phosphoric acid group. When m is 0 and z is 0, the alkyl group is directly bound to one of the oxygens of the phosphoric acid group. When m is 1 and z is 0, the alkyl group is directly bound to the oxygen of the ethoxy group farthest away from the phosphoric acid group. Although an ethoxy group is described, other alkoxy groups may be substituted such as a group of repeating pentoxy groups or heptoxy groups.

The compound represented by Formula 1 may be a compound represented by Formula 2 (SAIT-6) or Formula 3 (TDPA), or BYK 111 (BYK-chemie, Germany).

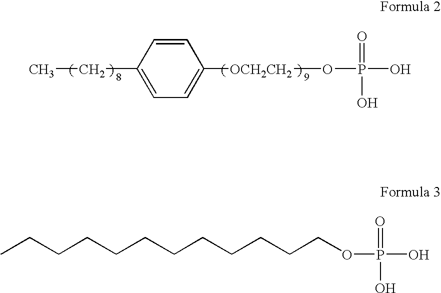

For Formula 2, m is 1, n is 9, z is 1, and k is 8. For Formula 3, m is 0, n is not applicable, k is 11, and z is 0. The hydrophilic portion and hydrophobic portion in Formulas 2 and 3 are illustrated below.

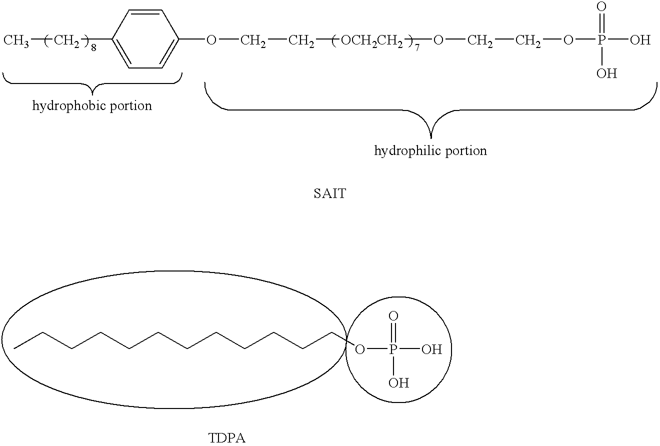

Another amphiphilic proton conductor for a fuel cell can be described as a phosphoric acid having d protons replaced by at least one string of molecules represented by the following formula:

Y—(X)ₘ—

wherein
Y is CH₃—(CH₂)ₖ-(phenylene)_{z}-;
X is -(alkoxy group)ₙ-; and
m is 0 or 1;
n is an integer between 1 and 10, inclusive;
z is 0 or 1;
k is an integer between 1 and 15, inclusive; and

wherein d is an integer.

In the above formula, d is an integer and is generally 1, 2, or 3. d indicates the number of strings of molecules that are bound to the oxygens of the phosphoric acid group. If d is 1, then one string of molecules according to the above formula is substituted for one of the protons of the phosphoric acid group and is bound to one of the oxygens of the phosphoric acid group. If d is two, then two strings of molecules according to the above formula substitute for two protons of the phosphoric acid group and one of the strings is bound to one oxygen, and the other string is bound to another oxygen. m determines the presence of a chain of alkoxy groups. If m is 1, then there is at least one alkoxy group in the string of molecules. If m is 0, then there are no alkoxy groups in the string of molecules and the hydrophobic portion of the string is directly bound to d oxygens of the phosphoric acid group. n identifies the number of alkoxy groups present in the string if m is 1. n is an integer between 1 and 10, inclusive. The alkoxy group can have about 1 to 10 carbons, but is generally an ethoxy group having two carbons. z determines the presence of the phenylene group. If z is 1, then a disubstituted benzene ring, the phenylene group, is present in the string of molecules. The phenylene group is generally para-phenylene, but may also be meta- or ortho-phenylene. If z is 0, then the alkyl group is directly bound to the alkoxy group, if present, or an oxygen of the phosphoric acid group. Finally, k determines the length of the alkyl group. k is generally between 1 and 15 resulting in an alkyl group having a total of between 2 and 16 carbons.

According to aspects of the present invention, there is provided a method of preparing an electrode for fuel cells.

First, a proton conductor as described above, a metal catalyst, a binder, and a solvent are mixed to obtain a composition for forming catalyst layers. Here, the amount of the proton conductor may be in the range of 1 to 20 parts by weight based on 100 parts by weight of the metal catalyst. When the amount of the proton conductor is less than 1 part by weight based on 100 parts by weight of the metal catalyst, the liquid electrolyte (phosphoric acid) distribution and fluidity cannot be sufficiently controlled. On the other hand, when the amount of the proton conductor is greater than 20 parts by weight based on 100 parts by weight of the metal catalyst, the electrode conductivity may decrease and flooding may occur as the amount of the phosphoric acid increases in the electrode.

The metal catalyst may be Pt, Fe, Co, Ni, Ru, Rh, Pd, Os, Ir, Cu, Ag, Au, Sn, Ti, Cr, a mixture thereof, an alloy thereof, or the carbon supported metal. The conductive catalyst material may further be carbon supported catalysts, such as Pt (Pt/C), a PtRu alloy (PtRu/C), or a PtCo alloy (PtCo/C).

The binder may be polyvinylidene fluoride (PVDF), vinylidene fluoride-hexafluoropropylene copolymer, or the like, and the amount of the binder may be in the range of 1 to 10 parts by weight based on 100 parts by weight of the metal catalyst. When the amount of the binder is outside this range, the catalyst layer cannot be easily formed and the electric conductivity of the catalyst layer may decrease.

The solvent may be at least one selected from the group consisting of N-methylpyrrolidone (NMP), dimethylacetamide (DMA or DMAc), dimethylformamide (DMF) and trifluoroacetic acid (TFA). And, the amount of the solvent may be in the range of 100 to 600 parts by weight based on 100 parts by weight of the metal catalyst. When the amount of the solvent is outside this range, the metal catalyst, etc., may not be uniformly distributed.

The obtained composition for forming catalyst layers may be cast on a supporting substrate, such as a gas diffusion layer (GDL), and the resultant is dried to obtain an electrode.

The drying temperature may be in the range of 60 to 150° C. When the drying temperature is less than 60° C., the drying cannot be sufficiently performed, and when the drying temperature is higher than 150° C., a carbon support may be oxidized.

Then, the electrode is treated with an acidic solution, such as phosphoric acid solution, and dried. The concentration of the phosphoric acid may be about 85% by weight.

A membrane electrode assembly (MEA) may be prepared according to aspects of the present invention.

The MEA may be prepared by placing the prepared electrodes on both sides of a polymer electrolyte membrane, and assembling them at a high temperature under a high pressure, or by coating an electrochemical metal catalyst on a polymer electrolyte membrane and assembling them with a gas diffusion layer.

The assembling may be performed at a temperature at which the polymer electrolyte membrane softens under 0.1 to 3 ton/cm², and more particularly, the assembly is effected at a temperature at which the polymer electrolyte membrane softens under about 1 ton/cm².

Then, each membrane electrode assembly is disposed between bipolar plates to complete the fuel cell. The bipolar plates distribute the fuel and oxidant within the cell, carry exhaust away from each cell, and separate the individual cells in the stack.

The above-described fuel cell may be used as a phosphoric acid fuel cell (PAFC), a proton exchange membrane fuel cell (PEMFC), or a direct methanol fuel cell (DMFC). The structures of these fuel cells and methods of manufacturing are not particularly limited and are described in detail in various references. Accordingly, the structure and manufacturing method of the fuel cell will not be described in detail herein.

The fuel cell may be operated at a temperature in the range of 60 to 200° C.

Hereinafter, aspects of the present invention will be described in more detail with reference to the following example. This example is for illustrative purposes only and is not intended to limit the scope of the present invention.

### EXAMPLE 1

### Preparation of Fuel Cell

1 g of a PtCo/C catalyst, 0.025 g of polyvinylidene fluoride (PVDF) as the binder, 5 ml of NMP as the solvent, and 0.025 g of SAIT-6 (Formula 2) were mixed and stirred at room temperature (25° C.) for 5 minutes to obtain a cathode slurry from which a cathode catalyst layer may be formed.

To prepare the cathode, the cathode slurry was coated on carbon paper using an applicator (gap: about 120 μm), and the resultant was dried at 80° C. for 1 hour, at 120° C. for 30 minutes, and at 150° C. for 10 minutes.

Separately, 1 g of PtRu/C, 0.025 g of PVDF as the binder, 5 ml of NMP as the solvent, and 0.025 g of SAIT-6 (Formula 2) were mixed and stirred at room temperature (25° C.) for 5 minutes to obtain an anode slurry from which an anode catalyst layer may be formed.

To prepare the anode, the anode slurry was coated on carbon paper using an applicator (gap: about 120 μm), and the resultant was dried at 80° C. for 1 hour, at 120° C. for 30 minutes, and at 150° C. for 10 minutes.

The formed cathode and anode were treated with phosphoric acid, and a polybenzimidazole (PBI) electrolyte membrane was disposed between the cathode and the anode to prepare a membrane electrode assembly. The membrane electrode assembly was then placed between two bipolar plates to complete the assembly of the unit fuel cell. Multiple unit fuel cells may be arranged to construct a fuel cell stack. However for demonstrative purposes, only a unit fuel cell was operated. Pure hydrogen was supplied to the anode at 100 ml/min and air was supplied to the cathode at 250 ml/min. The unit fuel cell was operated at 150° C.

### EXAMPLE 2

A unit fuel cell was prepared in the same manner as in Example 1, except that TDPA (Formula 3) was used instead of SAIT-6 (Formula 2) during the preparation of the composition from which the cathode and anode catalyst layers were formed.

### EXAMPLE 3

A fuel cell was prepared in the same manner as in Example 1, except that BYK111 was used instead of SAIT-6 (Formula 2) during the preparation of the composition from which the cathode and anode catalyst layers were formed.

### COMPARATIVE EXAMPLE 1

A fuel cell was prepared in the same manner as in Example 1, except that SAIT-6 (Formula 2) was not used during the preparation of the composition from which the cathode and anode catalyst layers were formed.

Viscosities of the slurries from which the cathode catalyst layers of Examples 1 to 3 and Comparative Example 1 were formed were measured, and the results are shown in Table 1.

TABLE 1

| Sample | Viscosity (cP) |
|---|---|
| Example 1 | 460 |
| Example 2 | 420 |
| Example 3 | 430 |
| Comparative Example 1 | 610 |

Referring to Table 1, the viscosities of the compositions from which the cathode catalyst layers of Examples 1 to 3 were formed were lower than the viscosity of the Comparative Example 1. Thus, the dispersive properties of the compositions from which cathode catalyst layers of Examples 1 to 3 were formed were improved indicating that the slurries of Examples 1, 2, and 3 are better mixed and more easily spread on the carbon paper to form the electrodes.

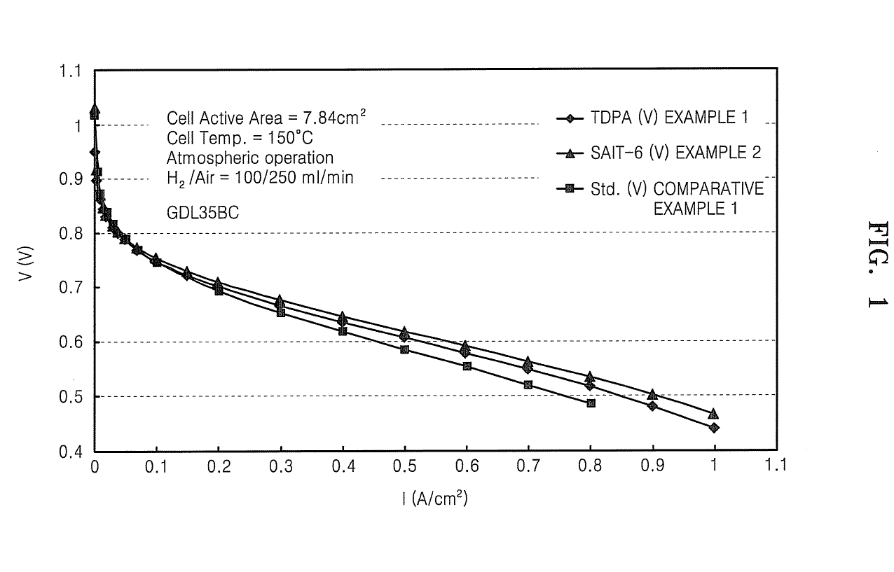

FIG. 1 is a graph illustrating voltage potentials with respect to the current densities in the fuel cells prepared according to Examples 1 and 2 and Comparative Example 1.

Referring to FIG. 1, the fuel cells prepared according to Examples 1 and 2 showed improved performance than fuel cells according to Comparative Example 1 in that the potentials across the unit fuel cells of Examples 1 and 2 were higher than the potential across the unit fuel cell of the Comparative Example 1.

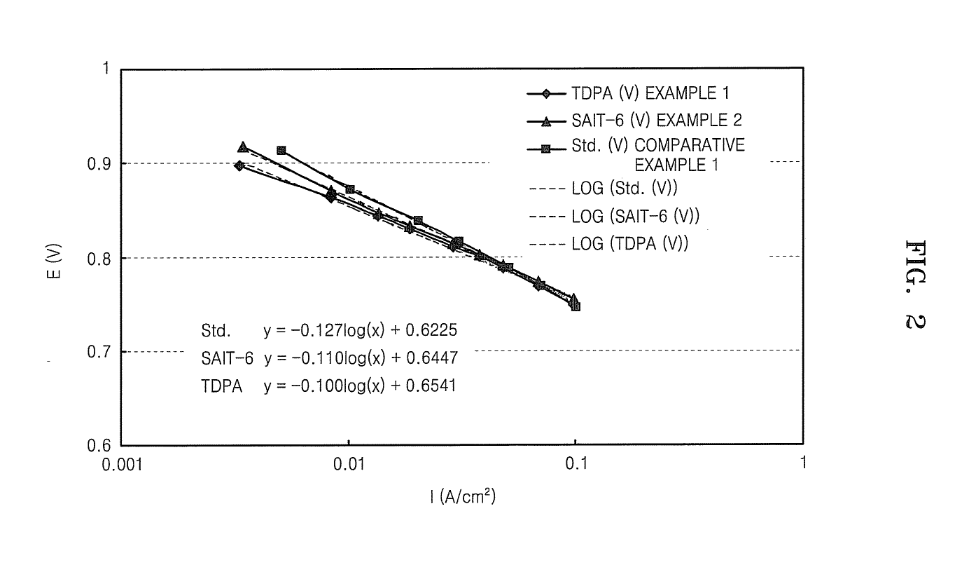

FIG. 2 is a graph illustrating voltage potentials in low current density regions in the fuel cells prepared according to Examples 1 and 2, and Comparative Example 1.

Referring to FIG. 2, the fuel cells prepared according to Examples 1 and 2 showed lower voltage decreases in the low current density regions than the fuel cell according to Comparative Example 1 as indicated by the slopes of the linear equations best-fit to the experimental data. Example 1 and Example 2 had slopes of −0.110 and −0.100, respectively; while Comparative Example 1 had a slope of −0.127. Thus, as current densities increase in the low current density region, voltage potentials across the unit fuel cells of Examples 1 and 2 decrease less quickly than voltage potential across the Comparative Example 1 decreases.

The proton conductor for a fuel cell according to aspects of the present invention is a phosphoric acid based mono-ester or di-ester including an amphiphilic block. When the proton conductor for fuel cells is added during the preparation of a composition from which catalyst layers are formed, the slurry from which the catalyst layers are formed has a decreased viscosity and improved dispersive properties. Also, in an electrode having the proton conductor, catalyst efficiency can be improved by effectively controlling phosphoric acid distribution due to the amphiphilic property of the proton conductor. A fuel cell having the above-described electrodes has an improved efficiency of electricity generation at high temperatures without requiring humidification.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A proton conductor for a fuel cell, comprising a phosphoric acid based compound comprising a hydrophilic block and a hydrophobic block.

2. The proton conductor of claim 1, wherein the phosphate ester based compound is represented by Formula 1 below: 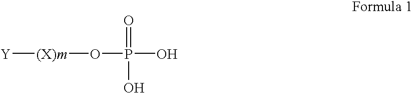
wherein X is —(OCH₂CH₂)ₙ—;
Y is CH₃—(CH₂)ₖ-(Phenylene)_{z}-;
n is an integer between 1 and 10, inclusive,
k is an integer between 1 and 15, inclusive,
m is 0 or 1, and
z is 0 or 1.

3. The proton conductor of claim 1, wherein the phosphoric acid based compound is represented by the following formula:

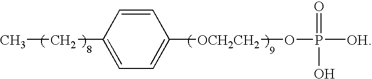

4. An electrode for a fuel cell, comprising:
the proton conductor of claim 1,
a metal catalyst, and
a binder.

5. The electrode of claim 4, wherein the amount of the proton conductor is in the range of 1 to 20 parts by weight based on 100 parts by weight of the metal catalyst.

6. A method of preparing an electrode for a fuel cell, comprising:
preparing a composition from which catalyst layers are formed by mixing the proton conductor of claim 1, a metal catalyst, a binder, and a solvent;
applying the composition to an electrode support;
drying the composition on the electrode support; and
treating the composition on the electrode support with an acidic solution.

7. The method of claim 6, wherein the binder is at least one of polyvinylidene fluoride and vinylidene fluoride-hexafluoropropylene copolymer, and the amount of the binder is in the range of 1 to 10 parts by weight based on 100 parts by weight of the metal catalyst.

8. The method of claim 6, wherein the solvent is at least one selected from the group consisting of N-methylpyrrolidone, dimethylacetamide, dimethylformamide and trifluoroacetic acid.

9. The method of claim 6, wherein the acidic solution is a phosphoric acid solution.

10. A fuel cell comprising:
an electrode comprising the proton conductor of claim 1, a metal catalyst, and a binder.

11. The fuel cell of claim 10, wherein the amount of the proton conductor is in the range of 1 to 20 parts by weight based on 100 parts by weight of the metal catalyst.

12. The proton conductor of claim 1, wherein the phosphoric acid based compound is represented by the following formula:

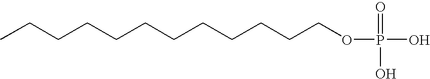

13. An amphiphilic proton conductor, comprising:
a hydrophilic block, and
at least one hydrophobic block.

14. The proton conductor of claim 13, wherein the hydrophilic block comprises a phosphoric acid group.

15. The proton conductor of claim 14, wherein the at least one hydrophobic block is bound to an oxygen of the phosphoric acid group.

16. The proton conductor of claim 15, wherein a first hydrophobic block is bound to a first oxygen of the phosphoric acid group and a second hydrophobic block is bound to a second oxygen of the phosphoric acid group.

17. The proton conductor of claim 13, wherein the at least one hydrophobic block further comprises an alkyl group.

18. The proton conductor of claim 17, wherein the alkyl group has between about 2 and 16 carbons.

19. The proton conductor of claim 17, wherein the alkyl group is a primary alkyl group.

20. The proton conductor of claim 13, wherein the at least one hydrophobic block further comprises a phenylene group bound to an alkyl group.

21. The proton conductor of claim 20, wherein the phenylene group is bound to the hydrophilic block and the alkyl group.

22. The proton conductor of claim 20, wherein the phenylene group is a para-phenylene group.

23. The proton conductor of claim 13, wherein the hydrophilic block comprises a phosphoric acid group and at least one alkoxy group chain, wherein the at least one alkoxy group chain is bound to an oxygen of the phosphoric acid group.

24. The proton conductor of claim 23, wherein the at least one alkoxy group chain comprises a chain of between about 1 to 10 individual alkoxy groups.

25. The proton conductor of claim 24, wherein the individual alkoxy groups have between about 1 and 7 carbons.

26. The proton conductor of claim 24, wherein the individual alkoxy groups are ethoxy groups.

27. The proton conductor of claim 23, wherein the at least one alkoxy group chain has between about 1 to 20 carbons.

28. The proton conductor of claim 23, wherein the at least one alkoxy group chain has between about 1 to 10 oxygens.

29. The proton conductor of claim 13, wherein
the hydrophilic block comprises a phosphoric acid group and at least one alkoxy group chain, and
the at least one hydrophobic block comprises a phenylene group and an alkyl group,
wherein the at least one alkoxy group chain is bound to an oxygen of the phosphoric acid group, and the phenylene group is bound to the at least one alkoxy group, and the alkyl group is bound to the phenylene group.
